(19) United States
(12) Patent Application Publication
(10) Pub. No.: US 2026/0185554 A1
(43) Pub. Date: Jul. 2, 2026

(54) Fastener, Male-Screw-Side Member, and Female-Screw-Side Member

(71) Applicant: pate.to Co., Ltd, Shizuoka (JP)

(72) Inventor: Yonefusa UCHIDA, Shizuoka (JP)

(73) Assignee: pate.to Co., Ltd, Shizuoka (JP)

(21) Appl. No.: 19/488,777

(22) PCT Filed: May 28, 2024
(86) PCT No.: PCT/JP2024/019462

§ 371 Date: Mar. 20, 2026

(30) Foreign Application Priority Data
May 30, 2023 (JP) 2023-089103

(51) Int. Cl. F16B 37/08; F16B 39/30

(52) U.S. Cl. CPC F16B 37/085; F16B 39/30

(57) ABSTRACT

Provided is a fastener capable of shortening the time required for fastening. The fastener includes: a male-screw-side member having a screw portion (11), the screw portion (11) being formed by alternately arranging male screw surfaces (12A, 12B) where male screw-side screw threads (12) are formed and outer peripheral pieces (13A, 13B) where the male screw-side screw threads (12) are not formed; and a female-screw-side member (20) having a screw hole (21), the screw hole (21) being formed by alternately arranging female screw surfaces (22A, 22B) where female screw-side screw threads (22) are formed and inner peripheral pieces (23A, 23B) where the female screw-side screw threads (22) are not formed, the screw hole (21) allowing the male screw surfaces (12A, 12B) and the female screw surfaces (22A, 22B) to be threadedly engaged with each other. The male screw-side screw threads (12) are formed in such a manner that a width in a radial direction of the screw portion (11) increases from a front side in a relative rotation direction toward a rear side during a thread engagement between the male screw surfaces (12A, 12B) and the female screw surfaces (22A, 22B). The female screw-side screw threads (22) are formed in such a manner that a width in a radial direction of the screw hole (21) decreases from the front side in the relative rotation direction toward the rear side.

### CROSS-REFERENCE TO RELATED APPLICATIONS

The present application claims priorities under 35 U.S.C. § 365 to PCT/JP 2024/019462 filed on May 28, 2024 and under 35 U.S.C. § 119 to Japanese Patent Application No. 2023-089103 filed on May 30, 2023, both of which are incorporated herein by reference in their entireties.

### TECHNICAL FIELD

The present disclosure relates to a fastener, a male-screw-side member, and a female-screw-side member.

### BACKGROUND

A fastener is for threadedly engaging and fastening a male screw and a female screw. For the fastener, PTL 1 discloses, for example, a technology to prevent loosening of a male screw and a female screw after fastening.

### CITATION LIST

### Patent Literature

PTL 1: Japanese Patent Application Laid-Open No. 2011-112204

### SUMMARY

In the conventional fastener as disclosed in the above-mentioned PTL 1, screw threads of a male screw and screw threads of a female screw are threadedly engaged and fastened by rotating the screws relative to each other by an amount corresponding to their respective lengths. Therefore, when the screw threads are long, fastening takes time.

Accordingly, an object of the present disclosure is to provide a fastener, a male-screw-side member, and a female-screw-side member capable of shortening the time required for fastening.

In order to solve the above-described problems, a fastener according to one aspect of the present disclosure includes: a male-screw-side member having a screw portion, the screw portion being formed by alternately arranging, in an outer peripheral direction, a male screw surface where male screw-side screw threads are formed and an outer peripheral piece where the male screw-side screw threads are not formed; and a female-screw-side member having a screw hole, the screw hole being formed by alternately arranging, in an inner peripheral direction, a female screw surface where female screw-side screw threads are formed and an inner peripheral piece where the female screw-side screw threads are not formed, the screw hole allowing the male screw surface and the female screw surface to be threadedly engaged with each other, the male screw-side screw threads being formed in such a manner that a width in a radial direction of the screw portion increases from a front side in a relative rotation direction toward a rear side in the relative rotation direction during a thread engagement between the male screw surface and the female screw surface, the female screw-side screw threads being formed in such a manner that a width in a radial direction of the screw hole decreases from the front side in the relative rotation direction toward the rear side in the relative rotation direction.

A second aspect of the present disclosure further includes a locking portion formed in the screw portion and the screw hole so as to lock a relative rotation between the screw portion and the screw hole in a thread engagement state between the male screw surface and the female screw surface.

In a third aspect of the present disclosure, the locking portion includes a protruding portion that is formed on the male screw-side screw thread, and a recessed portion that is formed on the female screw-side screw thread, the protruding portion being fitted into the recessed portion in the thread engagement state.

In a fourth aspect of the present disclosure, the protruding portion is formed at an end portion of the male screw-side screw thread on the rear side in the relative rotation direction, and the recessed portion is formed at an end portion of the female screw-side screw thread on the front side in the relative rotation direction.

In a fifth aspect of the present disclosure, the locking portion includes a protruding portion that is formed on the female screw-side screw thread, and a recessed portion that is formed on the male screw-side screw thread, the protruding portion being fitted into the recessed portion in the thread engagement state.

In a sixth aspect of the present disclosure, the protruding portion has a convexly curved surface shape on the front side in the relative rotation direction and a stepped shape on the rear side in the relative rotation direction, and the recessed portion has a concavely curved surface shape on the rear side in the relative rotation direction, the concavely curved surface shape corresponding to that on the front side of the protruding portion in the relative rotation direction, and the recessed portion also has a stepped shape on the front side in the relative rotation direction, the stepped shape corresponding to that on the rear side of the protruding portion in the relative rotation direction.

In a seventh aspect of the present disclosure, the screw portion has a tubular shape with a through-hole formed on an inner side thereof, the through-hole communicating with the screw hole in the thread engagement state between the male screw surface and the female screw surface.

An eighth aspect of the present disclosure further includes: a male screw-side pipe that is provided on a radially outer side of an axial center in the through-hole so that one end portion thereof faces in the relative rotation direction of the screw portion during thread engagement between the male screw surface and the female screw surface; and a female screw-side pipe that is provided on a radially outer side of an axial center in the screw hole so that one end portion thereof faces in the relative rotation direction of the screw hole during thread engagement between the male screw surface and the female screw surface, the one end portion being fitted into the one end portion of the male screw-side pipe in the thread engagement state.

A male-screw-side member according to a ninth aspect of the present disclosure includes: a male screw surface that is arranged in part of a screw portion in an outer peripheral direction and where male screw-side screw threads are formed; and an outer peripheral piece that is alternately arranged with the male screw surface in the outer peripheral direction to form an outer periphery of the screw portion, the outer peripheral piece not having the male screw-side screw threads formed thereon, the male screw-side screw threads being configured so that a width in a radial direction of the screw portion increases from a front side in a relative rotation direction toward a rear side in the relative rotation direction during a thread engagement with a screw hole.

A female-screw-side member according to a tenth aspect of the present disclosure includes: a female screw surface that is arranged in part of a screw hole in an inner peripheral direction and where female screw-side screw threads are formed; and an inner peripheral piece that is alternately arranged with the female screw surface in the inner peripheral direction to form an inner periphery of the screw hole, the inner peripheral piece not having the female screw-side screw threads formed thereon, the female screw-side screw threads being configured so that a width in a radial direction of the screw hole decreases from a front side in a relative rotation direction toward a rear side in the relative rotation direction during a thread engagement with a screw portion.

### Advantageous Effects of Disclosure

The fastener, male-screw-side member, and female-screw-side member according to the present disclosure can shorten the time required for fastening.

### BRIEF DESCRIPTION OF DRAWINGS

FIG. 1 is a perspective view of a fastener according to a first embodiment of the present disclosure.

FIG. 2 is a sectional view along a II-II line in FIG. 1.

FIG. 3 is a sectional view along a III-III line in FIG. 1.

FIG. 4 is an enlarged perspective view of a protruding portion illustrated in FIG. 2 and a recessed portion illustrated in FIG. 3.

FIG. 5 is a sectional view of a male-screw-side member according to a second embodiment of the present disclosure, corresponding to FIG. 2.

FIG. 6 is a sectional view of the female-screw-side member according to the present embodiment, corresponding to FIG. 3.

FIG. 7 is an axial sectional view schematically showing a state in which male screw surfaces are threadedly engaged with female screw surfaces according to the second embodiment of the present disclosure.

FIG. 8 is a partial enlarged view of a male screw-side pipe and a female screw-side pipe shown in FIG. 7.

### DESCRIPTION OF EMBODIMENTS

Hereinafter, embodiments of the present disclosure will be described with reference to the accompanying drawings. In order to facilitate understanding of the description, the same components are denoted by the same reference numerals in the respective drawings as much as possible, and redundant descriptions will be appropriately omitted.

### First Embodiment

Hereinafter, a first embodiment of the present disclosure will be described.

### Configuration

First, the configuration of a fastener 1 according to the first embodiment of the present disclosure (hereinafter referred to as “the present embodiment”) will be described.

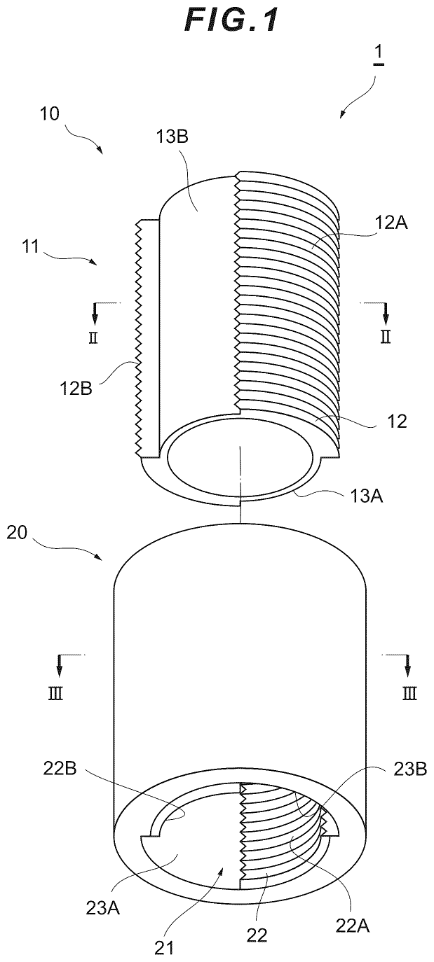

FIG. 1 is a perspective view of the fastener 1 according to the present embodiment. As shown in FIG. 1, the fastener 1 includes, as main portions, a male-screw-side member 10 and a female-screw-side member 20.

The male-screw-side member 10 includes, as a main portion, a tubular screw portion 11 having a through-hole 14 on the inner side.

The screw portion 11 extends in an axial direction in such a manner that male screw surfaces 12A, 12B where male screw-side screw threads 12 are formed and outer peripheral pieces 13A, 13B where the screw threads 12 are not formed are alternately arranged in an outer peripheral direction.

Roughly speaking, the outer peripheral piece 13A and the outer peripheral piece 13B have shapes formed by cutting off part of an outer peripheral surface of a cylindrical shape in the peripheral direction.

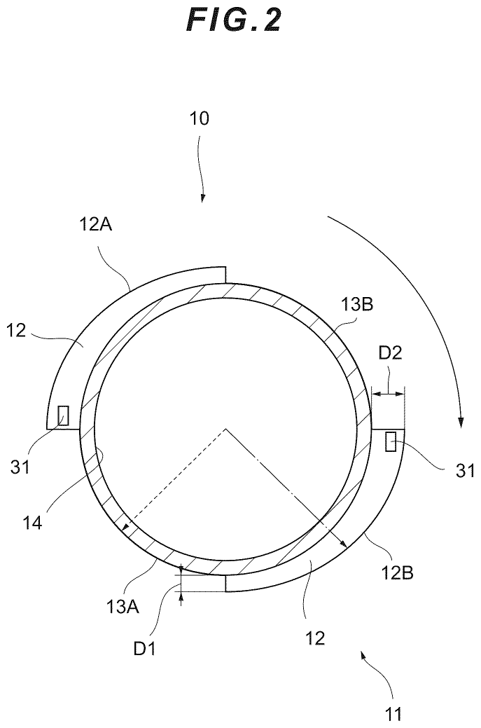

FIG. 2 is a sectional view taken along a II-II line of FIG. 1.

FIG. 2 shows that the screw portion 11 is formed in such a manner that the male screw surface 12A, the outer peripheral piece 13A, the male screw surface 12B, and the outer peripheral piece 13B are arranged in this order in the peripheral direction. A solid arrow in FIG. 2 indicates the relative rotation direction when the male screw surface 12A is being threadedly engaged with a female screw surface 22B described later and the male screw surface 12B is being threadedly engaged with a female screw surface 22A described later.

As shown in FIG. 2, the outer radius of the screw thread 12 (a dashed-dotted line arrow) is larger than the outer radius of the outer peripheral piece 13A and the outer peripheral piece 13B (a dashed line arrow).

In addition, the screw thread 12 is formed in such a manner that the width of the screw portion 11 in a radial direction increases from the front side in the relative rotation direction toward the rear side in the relative rotation direction. In other words, a width D2 is longer than a width D1 in FIG. 2.

Meanwhile, the female-screw-side member 20 shown in FIG. 1 includes a screw hole 21 as a main part.

The screw hole 21 extends in the axial direction in such a manner that female screw surfaces 22A, 22B where female screw-side screw threads 22 are formed and inner peripheral pieces 23A, 23B where the screw threads 22 are not formed are alternately arranged in an inner peripheral direction.

Roughly speaking, the inner peripheral piece 23A and the inner peripheral piece 23B have shapes formed by cutting off part of the inner peripheral surface of the cylindrical shape in the peripheral direction.

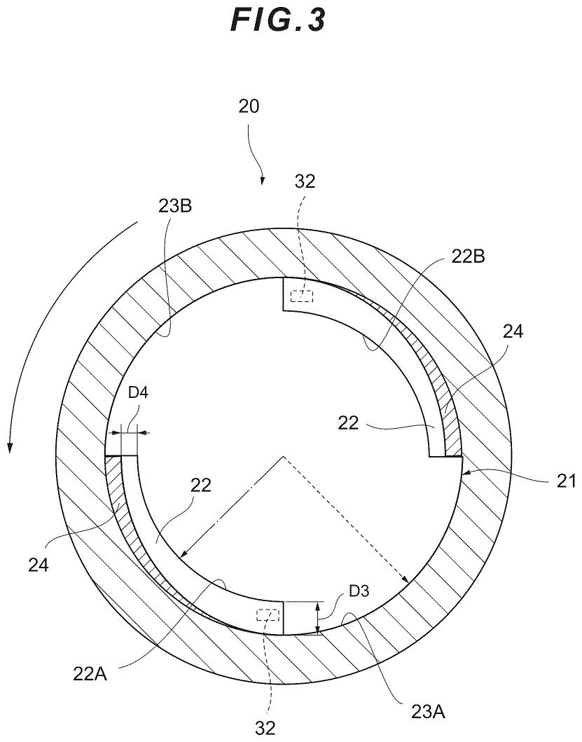

FIG. 3 is a sectional view taken along a III-III line of FIG. 1.

FIG. 3 shows that the screw hole 21 is formed in such a manner that the female screw surface 22A, the inner peripheral piece 23A, the female screw surface 22B, and the inner peripheral piece 23B are arranged in this order in the peripheral direction. A solid arrow in FIG. 3 indicates the relative rotation direction when the male screw surface 12A is being threadedly engaged with the female screw surface 22B described later and the male screw surface 12B is being threadedly engaged with the female screw surface 22A.

As shown in FIG. 3, in the screw hole 21, part of the screw thread 22 (a dashed-dotted line arrow) is smaller in hole radius than the inner peripheral piece 23A and the inner peripheral piece 23B (a dashed line arrow).

In addition, the screw thread 22 is formed in such a manner that the width in a radial direction of the screw hole 21 decreases from the front side in the relative rotation direction toward the rear side in the relative rotation direction. In other words, a width D4 is shorter than a width D3 in FIG. 3.

Here, the female screw surface 22A and the female screw surface 22B each have the screw threads 22 as well as a fan shaped member 24 that extends in the axial direction of the screw hole 21 on the outer side of the screw thread 22 (in the radial direction of the screw hole 21). The fan shaped member 24 is formed in the following manner. The width in the radial direction of the screw hole 21 increases from the front side in the relative rotation direction toward the rear side in the relative rotation direction so that the hole diameter of the screw hole 21 on the female screw surface 22A and the female screw surface 22B is made constant.

In other words, the female screw surface 22A and the female screw surface 22B are formed in such a manner that the hole diameter of the screw hole 21 is constant from the front side in the relative rotation direction toward the rear side in the relative rotation direction.

As a result, the female screw surface 22B can be threadedly engaged with the male screw surface 12A and the female screw surface 22A can be threadedly engaged with the male screw surface 12B. In other words, a thread engagement can be made so that, in the radially sectional view (the sectional views in FIGS. 2 and 3), the screw threads 12 overlap with the screw threads 22. By threadedly engaging these screw threads, the screw portion 11 can be fastened to the screw hole 21.

As described above, that is, in the radially sectional view, the fan shaped member 24 is provided to make the screw threads 12 overlap with the screw threads 22. Accordingly, the hole diameter of the screw hole 21 on the female screw surface 22A and the female screw surface 22B may not be completely constant but may be substantially constant (for example, an error range based on an average value of the maximum and minimum hole diameters is 3% or less).

In addition, the through-hole 14 of the tubular screw portion 11 communicates with the screw hole 21 in the thread engagement state. As a result, the male-screw-side member 10 and the female-screw-side member 20 can be used as a flow path for water piping, for example.

Here, the fastener 1 according to the present embodiment further includes protruding portions 31 shown in FIG. 2 and recessed portions 32 shown in FIG. 3. The protruding portions 31 and the recessed portions 32 are examples of the locking portion that is formed in the screw portion 11 and the screw hole 21 and that serves to lock a relative rotation between the screw portion 11 and the screw hole 21 in the thread engagement state between the male screw surfaces 12A, 12B and the female screw surfaces 22A, 22B.

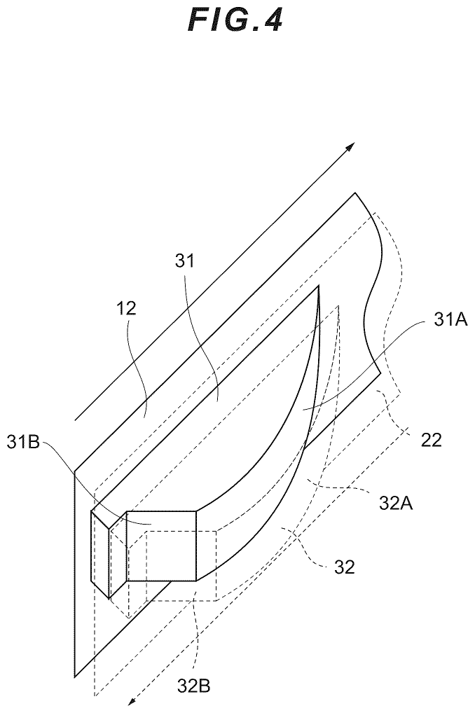

FIG. 4 is an enlarged perspective view of the protruding portion 31 illustrated in FIG. 2 and the recessed portion 32 illustrated in FIG. 3.

Here, in FIG. 4, a virtual line (dashed line) indicates the recessed portion 32 as viewed from the inside. FIG. 4 shows a fitted state between the protruding portion 31 and the recessed portion 32; however, for ease of understanding, the protruding portion 31 and the recessed portion 32 in the fitted state are illustrated as being slightly separated from each other.

A solid line arrow in FIG. 4 indicates the relative rotation direction of the screw portion 11 and the protruding portion 31 when the male screw surface 12A and the male screw surface 12B are being threadedly engaged with the female screw surface 22A and the female screw surface 22B so as to fasten the screw portion 11 to the screw hole 21, and a dashed line arrow in FIG. 4 indicates the relative rotation direction of the screw hole 21 and the recessed portion 32.

As shown in FIG. 4, the protruding portion 31 is formed on the surface of the screw thread 12. The protruding portion 31 may be provided in one or more of the plurality of screw threads 12 that are formed on the male screw surface 12A and the male screw surface 12B (FIG. 2 shows an example in which two protruding portions 31 are provided on the respective two screw threads 12).

The protruding portion 31 has a convexly curved surface shape on a front side 31A in the relative rotation direction and a stepped shape on a rear side 31B in the relative rotation direction.

The recessed portion 32 is formed on the surface of the screw thread 22. The recessed portions 32 may be equal in number to the protruding portions 31, and the recessed portions 32 may be provided at the locations corresponding to the protruding portions 31 in the thread engagement state between the male screw surfaces 12A, 12B and the female screw surfaces 22A, 22B (FIG. 3 shows an example in which two recessed portion 32 are provided in the respective two screw threads 22).

The recessed portion 32 is configured so that the protruding portion 31 fits thereinto when the male screw surfaces 12A, 12B are in a thread engagement state with the female screw surfaces 22A, 22B and configured to have a concavely curved surface shape on a rear side 32A in the relative rotation direction, the concavely curved surface shape corresponding to that on the front side 31A of the protruding portion 31, and also have a stepped shape on a front side 31B in the relative rotation direction, the stepped shape corresponding to that on the rear side 31B of the protruding portion 31.

Furthermore, in the present embodiment, it is preferable in the screw portion 11 that the outer peripheral piece 13A and the outer peripheral piece 13B be made longer than the male screw surface 12A and the male screw surface 12B, respectively. In the screw hole 21, it is preferable that the inner peripheral piece 23A and the inner peripheral piece 23B be made longer than the female screw surface 22A and the female screw surface 22B, respectively.

In particular, it is preferable that the outer peripheral piece 13A and the outer peripheral piece 13B have a length that is more than ½ but less than or equal to ⅔ of the entire perimeter of the screw portion 11 in the outer peripheral direction. It is also preferable that the inner peripheral piece 23A and the inner peripheral piece 23B have a length that is more than ½ but less than or equal to ⅔ of the entire perimeter of the screw hole 21 in the inner peripheral direction. By setting these lengths to more than ½, it becomes easy to insert the screw portion 11 into the screw hole 21. By setting these lengths to less than or equal to ⅔, it becomes possible to enhance the fastening power between the screw portion 11 and the screw hole 21.

More preferably, in the screw portion 11, the outer peripheral piece 13A and the outer peripheral piece 13B are made about 1% longer than the male screw surface 12A and the male screw surface 12B, respectively. In the screw hole 21, the inner peripheral piece 23A and the inner peripheral piece 23B are made about 1% longer than the female screw surface 22A and the female screw surface 22B, respectively.

The length of the screw portion 11 in the axial direction may be about 2.1 times the length of a conventional screw portion in its axial direction. The longer the screw portion 11 in the axial direction, the more the fastening power between the male-screw-side member 10 and the female-screw-side member 20 is enhanced. Suppose a case where the male screw surface 12A and the outer peripheral piece 13A are each equal in length in the peripheral direction and the same is true with the male screw surface 12B and the outer peripheral piece 13B, the female screw surface 22A and the inner peripheral piece 23A, and the female screw surface 22B and the inner peripheral piece 23B. In this case, when the length of the screw portion 11 in the axial direction is made twice the length of the conventional screw portion in the axial direction, the resulting fastening power thus becomes equivalent to that of a conventional fastener. However, in the case where the outer peripheral piece 13A and the outer peripheral piece 13B are made about 1% longer than the male screw surface 12A and the male screw surface 12B, and where the inner peripheral piece 23A and the inner peripheral piece 23B are made about 1% longer than the female screw surface 22A and female screw surface 22B, as described above, the fastening power becomes equivalent to that of the conventional fastener when the length in the axial direction is made about 2.1 times longer.

This concludes the description about the configuration of the fastener 1 according to the present embodiment.

### Operation

A description will now be given of the operation of the fastener 1 according to the present embodiment.

As shown in FIG. 1, the screw portion 11 is first inserted into the screw hole 21 at an angular position where the male screw surface 12A and the inner peripheral piece 23B, the male screw surface 12B and the inner peripheral piece 23A, the outer peripheral piece 13A and the female screw surface 22A, and the outer peripheral piece 13B and the female screw surface 22B are opposed to each other, respectively.

With the screw portion 11 inserted into the screw hole 21, the screw portion 11 and the screw hole 21 are fastened to each other by relatively rotating the screw portion 11 and the screw hole 21 by 90°, such that the male screw surface 12A is threadedly engaged with the female screw surface 22B and the male screw surface 12B is threadedly engaged with the female screw surface 22A.

For the thread engagement as described above, the narrowest side of the screw thread 12 on the male screw surface 12A (the front side in the relative rotation direction: the width D1 in FIG. 2) is first inserted from the widest side of the screw thread 22 on the female screw surface 22B (the front side in the relative rotation direction in FIG. 3).

In this state, as the relative rotation is further made, the narrowest side of the screw thread 12 on the male screw surface 12A (width D1 in FIG. 2) and the narrowest side of the screw thread 22 on the female screw surface 22B are threadedly engaged with each other, and the widest side of the screw thread 12 on the male screw surface 12A (width D2 in FIG. 2) and the widest side of the screw thread 22 of the female screw surface 22B are threadedly engaged with each other in the end in such a manner that they are in sliding contact with each other.

The above description for the thread engagement between the male screw surface 12A and the female screw surface 22B is also the same for the thread engagement between the male screw surface 12B and the female screw surface 22A.

As described above, since the protruding portions 31 and the recessed portions 32 fit to each other in a state where the male screw surface 12A and the male screw surface 12B are threadedly engaged with the female screw surface 22A and the female screw surface 22B, respectively, the relative rotation between the screw portion 11 and the screw hole 21 can be reliably locked.

Here, when the screw portion 11 and the screw hole 21 are rotated relative to each other so that the male screw surface 12A is threadedly engaged with the female screw surface 22B and the male screw surface 12B is threadedly engaged with the female screw surface 22A, the protruding portions 31 fit into the corresponding recessed portions 32 from the front side 31A having a convexly curved surface shape.

### Advantageous Effects

The fastener 1 according to the present embodiment includes: the male-screw-side member having the screw portion 11, the screw portion 11 being formed by alternately arranging, in an outer peripheral direction, the male screw surfaces 12A, 12B where the male screw-side screw threads 12 are formed and the outer peripheral pieces 13A, 13B where the male screw-side screw threads 12 are not formed; and the female-screw-side member 20 having the screw hole 21, the screw hole 21 being formed by alternately arranging, in an inner peripheral direction, the female screw surfaces 22A, 22B where the female screw-side screw threads 22 are formed and the inner peripheral pieces 23A, 23B where the female screw-side screw threads 22 are not formed, the screw hole 21 allowing the male screw surfaces 12A, 12B and the female screw surfaces 22A, 22B to be threadedly engaged with each other, the male screw-side screw threads 12 being formed in such a manner that the width in the radial direction of the screw portion 11 increases from the front side in the relative rotation direction toward the rear side in the relative rotation direction during a thread engagement between the male screw surfaces 12A, 12B and the female screw surfaces 22A, 22B, the female screw-side screw threads 22 being formed in such a manner that the width in the radial direction of the screw hole 21 decreases from the front side in the relative rotation direction toward the rear side in the relative rotation direction.

In contrast to the conventional screw portion in which the screw threads are continuous, the screw portion 11 includes the outer peripheral piece 13A and the outer peripheral piece 13B. Therefore, the screw threads 12 are short (provided that the length in the axial direction is the same as that of the conventional screw portion). Similarly, in contrast to the conventional screw hole in which the screw threads are continuous, the screw hole 21 includes the inner peripheral piece 23A and the inner peripheral piece 23B. Therefore, the screw threads 22 are short (provided that the length in the axial direction is the same as that of the conventional screw hole). Thus, the fastener 1 according to the present embodiment can shorten the time required for fastening more than before.

In addition, when the male screw surfaces 12A, 12B are threadedly engaged with the female screw surfaces 22A, 22B, the narrowest side of the screw thread 12 is first inserted into the screw thread 22, reducing friction at the beginning of insertion and allowing easy thread engagement.

Moreover, in the thread engagement state, the widest side of the screw thread 12 and the widest side of the screw thread 22 are in sliding contact with each other. This configuration makes it possible to increase the area of a sliding contact portion and to prevent the thread engagement state from loosening.

In the fastener 1 according to the present embodiment, the outer peripheral pieces 13A, 13B are longer than the male screw surfaces 12A, 12B in the peripheral direction and the inner peripheral pieces 23A, 23B are longer than the female screw surfaces 22A, 22B in the peripheral direction.

As described in the foregoing, when the screw portion 11 is inserted into the screw hole 21, the screw portion 11 is first inserted into the screw hole 21 at an angular position where the male screw surface 12A and the inner peripheral piece 23B, the male screw surface 12B and the inner peripheral piece 23A, the outer peripheral piece 13A and the female screw surface 22A, and the outer peripheral piece 13B and the female screw surface 22B are opposed to each other, respectively. Therefore, when the outer peripheral pieces 13A, 13B are made longer than the male screw surfaces 12A, 12B in the peripheral direction, and the inner peripheral pieces 23A, 23B are made longer than the female screw surfaces 22A, 22B in the peripheral direction, it is possible to prevent the screw threads 12 on the male screw surfaces 12A, 12B from abutting the screw threads 22 on the female screw surfaces 22A, 22B even if a slight angular deviation occurs during insertion, and therefore insertion can be carried out smoothly.

The fastener 1 according to the present embodiment further includes the locking portion formed in the screw portion 11 and the screw hole 21 so as to lock a relative rotation between the screw portion 11 and the screw hole 21 in the thread engagement state between the male screw surfaces 12A, 12B and the female screw surfaces 22A, 22B.

This configuration can prevent loosening of the engagement state between the male screw surfaces 12A and 12B and the female screw surfaces 22A and 22B.

In the present embodiment, the locking portion includes the protruding portion 31 that is formed on the male screw-side screw thread 12, and the recessed portion 32 that is formed on the female screw-side screw thread 22, the protruding portion 31 being fitted into the recessed portion 32 in the thread engagement state.

Such a simple structure can thus prevent the thread engagement state between the male screw surfaces 12A, 12B and the female screw surfaces 22A, 22B from loosening.

In the present embodiment, the protruding portion 31 is formed at an end portion of the male screw-side screw thread 12 on the rear side in the relative rotation direction, and the recessed portion 32 is formed at an end portion of the female screw-side screw thread 22 on the front side in the relative rotation direction.

As a result, when the screw portion 11 and the screw hole 21 are rotated relative to each other so as to threadedly engage the male screw surface 12A and the male screw surface 12B with the female screw surface 22A and the female screw surface 22B, respectively, the length of contact between the protruding portion 31 of the male screw-side screw threads 12 and the surface of the female screw-side screw thread 22 is shortened, and, as a result, more smooth fitting can be achieved.

In the present embodiment, the locking portion may include the protruding portion 31 that is formed on the female screw-side screw thread 22, and the recessed portion 32 that is formed on the male screw-side screw threads 12, the protruding portion 31 being fitted into the recessed portion 32 in the thread engagement state. Such a simple structure can thus prevent the thread engagement state between the male screw surfaces 12A, 12B and the female screw surfaces 22A, 22B from loosening.

In the present embodiment, the protruding portion 31 has a convexly curved surface shape on the front side 31A in the relative rotation direction and a stepped shape on the rear side 31B in the relative rotation direction. The recessed portion 32 has a concavely curved surface shape on the rear side 32A in the relative rotation direction, the concavely curved surface shape corresponding to that on the front side 31A of the protruding portion 31 in the relative rotation direction. The recessed portion 32 also has a stepped shape on the front side 32B in the relative rotation direction, the stepped shape corresponding to that on the rear side 31B of the protruding portion 31 in the relative rotation direction.

As a result, when the screw portion 11 and the screw hole 21 are rotated relative to each other so as to threadedly engage the male screw surface 12A and the male screw surface 12B with the female screw surface 22A and the female screw surface 22B, respectively, the protruding portion 31 fits into the recessed portion 32 from the front side 31A in the relative rotation direction, the recessed portion having a convexly curved surface shape on the front side 31A. Thus, this configuration allows smooth fitting. At the time of removal, the protruding portion 31 is removed from the rear side 31B in the relative rotation direction, the protruding portion 31 having a stepped shape on the rear side 31B. This configuration allows easy removal as compared with a case where the protruding portion 31 has a vertical face on the rear side 31B of the protruding portion 31 in the relative rotation direction.

In the present embodiment, the screw portion 11 has a tubular shape with the through-hole 14 formed on an inner side, the through-hole 14 communicating with the screw hole 21 in the thread engagement state between the male screw surfaces 12A, 12B and the female screw surfaces 22A, 22B.

As a result, the male-screw-side member and the female-screw-side member can be used as a flow path for water piping, which leads to enhanced convenience.

The male-screw-side member 10 according to the present embodiment includes: the male screw surfaces 12A, 12B that are arranged in part of the screw portion 11 in the outer peripheral direction and where the male screw-side screw threads 12 are formed; and the outer peripheral pieces 13A, 13B that are alternately arranged with the male screw surfaces 12A, 12B in the outer peripheral direction to form an outer periphery of the screw portion 11, the outer peripheral pieces 13A, 13B not having the male screw-side screw threads 12 formed thereon, the male screw-side screw threads 12 being configured so that the width in the radial direction of the screw portion 11 increases from the front side in the relative rotation direction toward the rear side in the relative rotation direction during a thread engagement with the screw hole 21 (that is, during a thread engagement between the male screw surfaces 12A, 12B and the female screw surfaces 22A and 22B).

In contrast to the conventional screw portion of the male screw in which the screw threads are continuous, the screw portion 11 includes the outer peripheral piece 13A and the outer peripheral piece 13B. Therefore, the screw threads 12 are short (provided that the length in the axial direction is the same as that of the conventional screw portion), so that this configuration can shorten the time required for fastening more than before.

In addition, when the male screw surfaces 12A, 12B are threadedly engaged with the female screw surfaces, the narrowest side of the screw thread 12 is first inserted to between the female screw-side screw threads 22, which reduces friction at the beginning of insertion and allows easy thread engagement.

In the thread engagement state, even the widest side of the screw thread 12 is inserted therein. This configuration makes it possible to increase the area of a sliding contact portion with the female screw-side screw thread 22, thereby preventing the thread engagement state from loosening.

The female-screw-side member 20 according to the present embodiment includes: the female screw surfaces 22A, 22B that are arranged in part of the screw hole 21 in the inner peripheral direction and where the female screw-side screw threads 22 are formed, and the inner peripheral pieces 23A, 23B that are alternately arranged with the female screw surfaces 22A, 22B in the inner peripheral direction to form the inner periphery of the screw hole 21, the inner peripheral pieces 23A, 23B not having the female screw-side screw threads formed thereon, the female screw-side screw thread 22 being configured so that the width in the radial direction of the screw hole 21 decreases from the front side in the relative rotation direction toward the rear side in the relative rotation direction during a thread engagement with the screw portion 11 (that is, during a thread engagement between the male screw surfaces 12A, 12B and the female screw surfaces 22A and 22B).

In contrast to the conventional screw hole of the female screw in which the screw threads are continuous, the screw hole 21 includes the inner peripheral piece 23A and the inner peripheral piece 23B. Therefore, the screw threads 22 are short (provided that the length in the axial direction is the same as that of the conventional screw hole), so that this configuration can shorten the time required for fastening more than before.

In addition, when the female screw surfaces 22A, 22B are threadedly engaged with the male screw surfaces 12A, 12B, the narrowest side of the screw thread 22 is first inserted to between the male screw-side screw threads 12, which reduces friction at the beginning of insertion and allows easy thread engagement.

In the thread engagement state, even the widest side of the screw thread 22 is inserted therein. This configuration makes it possible to increase the area of a sliding contact portion with the male screw-side screw threads 12, thereby preventing the thread engagement state from loosening.

### Second Embodiment

Hereinafter, a second embodiment of the present disclosure will be described.

### Configuration

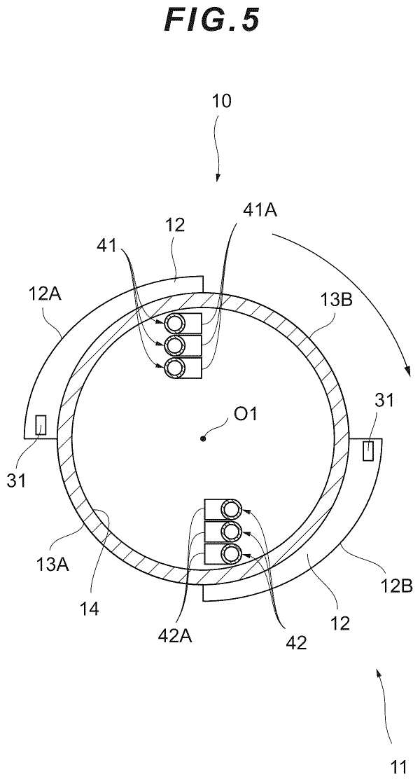

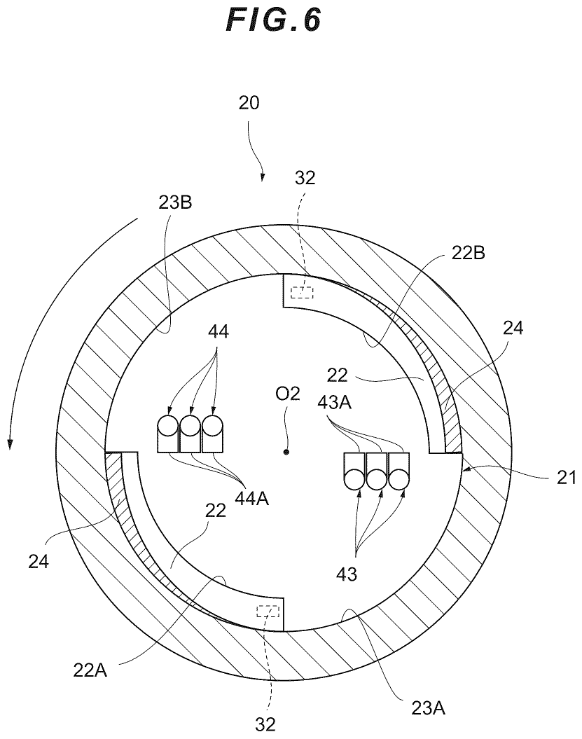

FIG. 5 is a sectional view of a male-screw-side member according to a second embodiment of the present disclosure (hereinafter, referred to as “the present embodiment”), corresponding to FIG. 2. FIG. 6 is a sectional view of a female-screw-side member according to the present embodiment, corresponding to FIG. 3.

The present embodiment further includes, in addition to the configuration of the fastener 1 according to the first embodiment of the present disclosure, first male screw-side pipes 41 and second male screw-side pipes 42 shown in FIG. 5, and first female screw-side pipes 43 and second female screw-side pipes 44 shown in FIG. 6.

As shown in FIG. 5, the first male screw-side pipes 41 have an outer diameter less than the radius of the through-hole 14 and are provided on a radially outer side of an axial center O1 in the through-hole 14. Here, in FIG. 5, the three first male screw-side pipes 41 are arranged in the radial direction of the screw portion 11 (that is, in the radial direction of the through-hole 14). However, the number of the first male screw-side pipes 41 may be one or more.

The first male screw-side pipes 41 extend in the axial direction of the screw portion 11 (that is, in the axial direction of the through-hole 14). In addition, as shown in FIG. 5, end portions 41A on the tip side of the screw portion 11 are provided so as to face in the relative rotation direction of the screw portion 11 (an arrow direction in FIG. 5) when the male screw surfaces 12A, 12B are threadedly engaged with the female screw surfaces 22A, 22B.

The second male screw-side pipes 42 have an outer diameter less than the radius of the through-hole 14 and are provided on a radially outer side of the axial center O1 in the through-hole 14. Here, in FIG. 5, the three second male screw-side pipes 42 are arranged in the radial direction of the screw portion 11 (that is, in the radial direction of the through-hole 14). However, the number of the second male screw-side pipes 42 may be one or more.

The second male screw-side pipes 42 extend in the axial direction of the screw portion 11 (that is, in the axial direction of the through-hole 14). In addition, as shown in FIG. 5, end portions 42A on the tip side of the screw portion 11 are provided so as to face in the relative rotation direction of the screw portion 11 (an arrow direction in FIG. 5) when the male screw surfaces 12A, 12B are threadedly engaged with the female screw surfaces 22A, 22B.

In addition, the second male screw-side pipes 42 are arranged so as to be spaced apart from the respective first male screw-side pipes 41 by an angle (180°), which is twice the relative rotation angle (90°) during thread engagement between the male screw surfaces 12A, 12B and the female screw surfaces 22A, 22B.

As shown in FIG. 6, the first female screw-side pipes 43 have an outer diameter less than the radius of the screw hole 21 and are provided on a radially outer side of an axial center 02 in the screw hole 21. Here, in FIG. 6, the three first female screw-side pipes 43 are arranged in the radial direction of the screw hole 21. However, the number of the first female screw-side pipes 43 is the same as the number of the first male screw-side pipes 41.

The first female screw-side pipes 43 extend in the axial direction of the screw hole 21. In addition, as shown in FIG. 6, end portions 43A on an inlet side of the screw hole 21 are provided so as to face in the relative rotation direction of the screw hole 21 (an arrow direction in FIG. 6) when the male screw surfaces 12A, 12B are threadedly engaged with the female screw surfaces 22A, 22B.

The second female screw-side pipes 44 have an outer diameter less than the radius of the screw hole 21 and are provided on a radially outer side of the axial center 02 in the screw hole 21. Here, in FIG. 6, the three second female screw-side pipes 44 are arranged in the radial direction of the screw hole 21. However, the number of the second female screw-side pipes 44 is the same as the number of the second male screw-side pipes 42.

The second female screw-side pipes 44 extend in the axial direction of the screw hole 21, and as shown in FIG. 6, end portions 44A on the inlet side of the screw hole 21 are provided so as to face in the relative rotation direction of the screw hole 21 (an arrow direction in FIG. 6) when the male screw surfaces 12A, 12B are threadedly engaged with the female screw surfaces 22A, 22B.

In addition, the second female screw-side pipes 44 are arranged so as to be spaced apart from the respective first female screw-side pipes 43 by an angle (180°), which is twice the relative rotation angle (90°) during thread engagement between the male screw surfaces 12A, 12B and the female screw surfaces 22A, 22B.

In addition, the first female screw-side pipes 43 are arranged to be spaced apart from the first male screw-side pipes 41 toward the front side in the relative rotation direction of the screw portion 11 (that is, toward the rear side in the relative rotation direction of the screw hole 21) by 90° that is the relative rotation angle of the screw portion 11 during thread engagement. The second female screw-side pipes 44 are also arranged to be spaced apart from the second male screw-side pipes 42 toward the front side in the relative rotation direction of the screw portion 11 (that is, toward the rear side in the relative rotation direction of the screw hole 21) by 90° that is the relative rotation angle of the screw portion 11 during thread engagement.

In other words, at the time of inserting the screw portion 11 into the screw hole 21, as shown in FIGS. 5 and 6, the first male screw-side pipes 41, the first female screw-side pipes 43, the second male screw-side pipes 42, and the second female screw-side pipes 44 are in the state of being provided at positions offset from each other by 90°.

As a result, when the screw portion 11 is first linearly inserted into the screw hole 21, there is no contact between the male screw-side pipes 41, 42 and the female screw-side pipes 43, 44. Then, in the state where the screw portion 11 is inserted into the screw hole 21, the screw portion 11 and the screw hole 21 are rotated relative to each other to threadedly engage the male screw surfaces 12A, 12B with the female screw surfaces 22A, 22B.

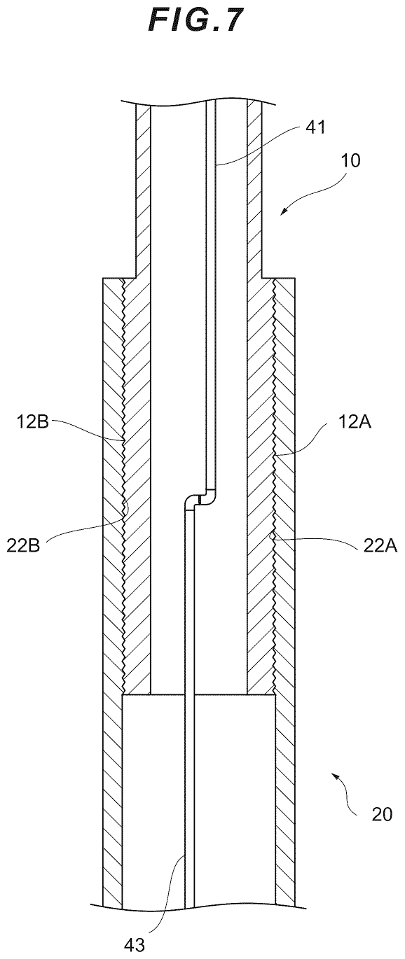

Here, FIG. 7 is an axial sectional view schematically showing the state in which the male screw surfaces 12A, 12B are threadedly engaged with the female screw surfaces 22A, 22B. In FIG. 7, the second male screw-side pipes 42 and the second female screw-side pipes 44 are omitted.

In the thread engagement state between the male screw surfaces 12A, 12B and the female screw surfaces 22A, 22B, as shown in FIG. 7, the end portions 43A of the first male screw-side pipes 43 fit into the end portions 41A of the first male screw-side pipes 41, and the end portions 44A of the second female screw-side pipes 44 fit into the end portions 42A of the second male screw-side pipes 42.

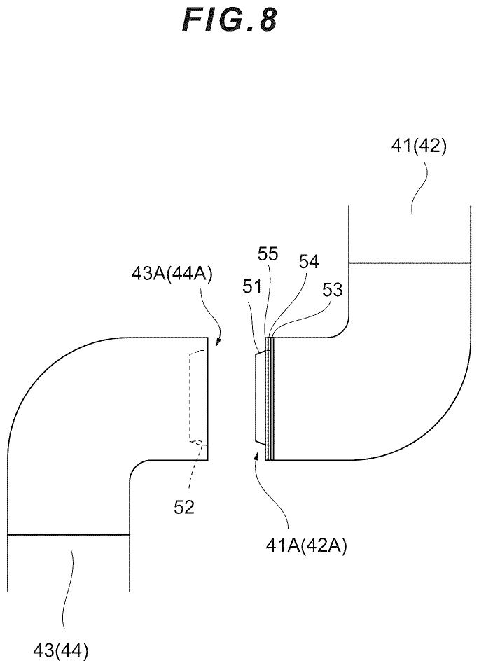

FIG. 8 is an enlarged view of the end portion 41A of the first male screw-side pipe 41 and the end portion 43A of the first female screw-side pipe 43.

At the end portion 41A, an annular projection portion 51 is formed. At the end portion 43A, an annular depression portion 52 corresponding to the shape of the projection portion 51 is formed.

Moreover, at the base of the projection portion 51 on the end portion 41A, a spring washer 53, a washer 54, and an O-ring 55 are provided to be stacked in sequence. By providing these components, it is possible to ensure sealability in a portion where the first male screw-side pipe 41 and the first female screw-side pipe 43 fits into each other without any gap when the end portion 41A having the projection portion 51 formed thereon fits into the end portion 43A having the depression portion 52 formed thereon.

However, the configuration of the end portion 41A of the first male screw-side pipe 41 and the configuration of the end portion 43A of the first female screw-side pipe 43 may be reversed.

The above description with reference to FIG. 8 also applies to the end portion 42A of the second male screw-side pipe 42 and the end portion 44A of the second female screw-side pipe 44.

In the present embodiment, the axial positions and/or peripheral positions of the end portions 41A of the plurality of first male screw-side pipes 41 may be made different from each other. Similarly, the axial positions and/or peripheral positions of the end portions 42A of the plurality of second male screw-side pipes 42 may be made different from each other.

### Advantageous Effects

The fastener 1 according to the present embodiment further includes: the male screw-side pipes 41, 42 that are provided on the radially outer side of the axial center O1 in the through-hole 14 so that one end portions 41A, 42A face in the relative rotation direction of the screw portion 11 during thread engagement between the male screw surfaces 12A, 12B and the female screw surfaces 22A, 22B; and the female screw-side pipes 43, 44 that are provided on a radially outer side of the axial center O2 in the screw hole 21 so that one end portions 43A, 44A face in the relative rotation direction of the screw hole 21 during thread engagement between the male screw surfaces 12A, 12B and the female screw surfaces 22A, 22B, the one end portions 43A, 44A fitting into the one end portions 41A, 42A of the male screw-side pipes 41, 42 in the thread engagement state between the male screw surfaces 12A, 12B and the female screw surfaces 22A, 22B.

As a result, in the thread engagement state between the male screw surfaces 12A, 12B and the female screw surfaces 22A, 22B, the male screw-side pipes 41, 42 communicate with the female screw-side pipes 43, 44, respectively. As a result, these pipes can be used for applications independent of the male-screw-side member 10 and the female-screw-side member 20, thereby leading to more enhanced convenience.

Examples of the applications of the first male screw-side pipe 41 and the first female screw-side pipe 43 that communicate with each other include flow paths for fluids and flow paths for solids (in the case of two or more first male screw-side pipes 41 and two or more first female screw-side pipes 43), hydraulic supply lines and hydraulic return lines (in the case of two or more first male screw-side pipes 41 and two or more first female screw-side pipes 43), arrangement of electrical wires (such as a single-phase three-wire system in the case of three or more first male screw-side pipes 41 and three or more first female screw-side pipes 43), and gas flow paths (such as O2, N, and CO2 flow paths in the case of three or more first male screw-side pipes 41 and three or more first female screw-side pipes 43).

The applications of the second male screw-side pipes 42 and the second female screw-side pipes 44 that communicate with each other are the same as above. Therefore, the applications of the first male screw-side pipes 41 and the first female screw-side pipes 43 may be made different from the applications of the second male screw-side pipes 42 and the second female screw-side pipes 44.

### Modification

The present disclosure is not limited to the above-described embodiments. That is, the above-described specific examples in which design changes have been appropriately made by a person skilled in the art are encompassed by the scope of the present disclosure as long as the features of the present disclosure are included. In addition, the respective elements included in the above-described embodiments and following modifications can be combined as long as the combinations are technically possible, and those obtained by the combinations thereof are also encompassed by the scope of the present disclosure as long as they include the features of the present disclosure.

For example, in each embodiment, the screw portion 11 includes two male screw surfaces and two outer peripheral pieces, and the screw hole 21 includes two female screw surfaces and two inner peripheral pieces. However, the present disclosure does not limit the number of these surfaces. That is, the configuration is acceptable as long as the screw portion 11 includes one or more male screw surfaces and one or more outer peripheral pieces, and as long as the screw hole 21 includes one or more female screw surfaces and one or more inner peripheral pieces. However, it is preferable that the numbers of the male screw surfaces, the outer peripheral pieces, the female screw surfaces, and the inner peripheral pieces be the same.

The angle of relative rotation between the screw portion 11 and the screw hole 21 necessary for threadedly engaging the male screw surfaces with the female screw surfaces varies depending on the number of the male screw surfaces and the female screw surfaces.

For example, in a case where the lengths of the male screw surface, the outer peripheral piece, the female screw surface, and the inner peripheral piece in the peripheral direction are the same, the angle of relative rotation is 180° when each of the unit counts of the male screw surface, the outer peripheral piece, the female screw surface, and the inner peripheral piece is one.

When each of the unit counts of the male screw surface, the outer peripheral piece, the female screw surface, and the inner peripheral piece is two, the angle of the relative rotation is 90° (the above-mentioned embodiments use this shape as an example).

When each of the unit counts of the male screw surface, the outer peripheral piece, the female screw surface, and the inner peripheral piece is three, the angle of the relative rotation is 60°.

When each of the unit counts of the male screw surface, the outer peripheral piece, the female screw surface, and the inner peripheral piece is four, the angle of the relative rotation is 45°.

That is, as the number of each of the surfaces increases, the angle of the relative rotation between the screw portion 11 and the screw hole 21 decreases, so that the time required for fastening can be shortened.

Furthermore, regardless of each of the numbers of the surfaces, it is preferable that the outer peripheral piece be made longer than the male screw surface in the peripheral direction and also that the inner peripheral piece be made longer than the female screw surface in the peripheral direction. When they are formed in this manner, the angle of the relative rotation naturally changes.

Alternatively, the outer peripheral piece may be made shorter than the male screw surface in the peripheral direction, and the inner peripheral piece may be made shorter than the female screw surface in the peripheral direction. This configuration improves the fastening power between the screw portion 11 and the screw hole 21.

In addition, in the second embodiment described above, since the relative rotation angle is 90° during thread engagement between the male screw surfaces 12A, 12B and the female screw surfaces 22A, 22B, the first male screw-side pipes 41, the first female screw-side pipes 43, the second male screw-side pipes 42, and the second female screw-side pipes 44 are provided at positions offset from each other by 90°. However, if the relative rotation angle changes as described above, the respective pipes are arranged apart from each other at an angle equal to the said relative rotation angle.

Furthermore, the screw threads 12 and the screw threads 22 may not be inclined relative to the axial direction of the screw portion 11 and the screw hole 21 like conventional screws. In the conventional screw, the screw portion is rotated to advance the screw into the screw hole.

However, since the fastener 1 is configured such that the screw portion 11 is first linearly inserted into the screw hole 21 while the inner peripheral piece 23A and the inner peripheral piece 23B face the male screw surface 12A and the male screw surface 12B, respectively, and is rotated to achieve the thread engagement. Thus, there is no need for the fastener 1 to be advanced in the axial direction during rotation.

In addition, the respective shapes of the screw threads 12 and the screw threads 22 are not limited to those shown in FIGS. 1 to 8 and can be changed to various shapes.

Furthermore, the protruding portion 31 may be formed on each of the female screw surface 22A and the female screw surface 22B, and the recessed portion 32 may be formed on each of the male screw surface 12A and the male screw surface 12B. In this case also, the protruding portion 31 has a convexly curved surface shape on the front side 31A in the relative rotation direction and also has a stepped shape on the rear side 31B in the relative rotation direction. The recessed portion 32 is configured such that the protruding portion 31 is fitted into the recessed portion 32 in the thread engagement state between the male screw surfaces 12A, 12B and the female screw surfaces 22A, 22B, and has a concavely curved surface shape on the rear side 32A in the relative rotation direction, the concavely curved surface shape corresponding to that on the front side 31A of the protruding portion 31 and also has a stepped shape on the front side 32B, the stepped shape corresponding to that on the rear side 31B of the protruding portion 31 in the relative rotation direction.

The male-screw-side member 10 may have a head portion like normal male screws. In addition, the screw portion 11 may be formed as a solid part without internal through-hole 14 like conventional screw portions. The female-screw-side member 20 may be bottomed on the side opposite to the inlet side (i.e., the side where the male-screw-side member is to be inserted).

In addition, the fastener 1 can be used for those having a diameter of several cm to several tens of meters. As for the material, various materials such as metal, vinyl chloride, glass, and the like can be applied.

### REFERENCE SIGNS LIST

1 fastener, 10 . . . male-screw-side member, 11 . . . screw portion, 12 . . . (male screw-side) screw thread, 12A, 12B . . . male screw surface, 13A, 13B . . . outer peripheral piece, 14 . . . through-hole, 20 . . . female-screw-side member, 21 . . . screw hole, 22 . . . (female screw-side) screw thread, 22A, 22B . . . female screw surface, 23A, 23B . . . inner peripheral piece, 24 . . . fan shaped member, 31 . . . protruding portion, 32 . . . recessed portion, 41 . . . first male screw-side pipe, 42 . . . second male screw-side pipe, 43 . . . first female screw-side pipe, 44 . . . second female screw-side pipe

What is claimed is:

1. A fastener comprising:
a male-screw-side member having a screw portion, the screw portion being formed by alternately arranging, in an outer peripheral direction, a male screw surface where male screw-side screw threads are formed and an outer peripheral piece where the male screw-side screw threads are not formed;
a female-screw-side member having a screw hole, the screw hole being formed by alternately arranging, in an inner peripheral direction, a female screw surface where female screw-side screw threads are formed and an inner peripheral piece where the female screw-side screw threads are not formed, the screw hole allowing the male screw surface and the female screw surface to be threadedly engaged with each other,
the male screw-side screw threads being formed in such a manner that a width in a radial direction of the screw portion increases from a front side in a relative rotation direction toward a rear side in the relative rotation direction during a thread engagement between the male screw surface and the female screw surface,
the female screw-side screw threads being formed in such a manner that a width in a radial direction of the screw hole decreases from the front side in the relative rotation direction toward the rear side in the relative rotation direction.

2. The fastener according to claim 1, further comprising a locking portion formed in the screw portion and the screw hole so as to lock a relative rotation between the screw portion and the screw hole in a thread engagement state between the male screw surface and the female screw surface.

3. The fastener according to claim 2, wherein the locking portion includes:
a protruding portion that is formed on the male screw-side screw thread; and
a recessed portion that is formed on the female screw-side screw thread, the protruding portion being fitted into the recessed portion in the thread engagement state.

4. The fastener according to claim 3, wherein:
the protruding portion is formed at an end portion of the male screw-side screw thread on the rear side in the relative rotation direction; and
the recessed portion is formed at an end portion of the female screw-side screw thread on the front side in the relative rotation direction.

5. The fastener according to claim 2, wherein the locking portion includes:
a protruding portion that is formed on the female screw-side screw thread; and
a recessed portion that is formed on the male screw-side screw thread, the protruding portion being fitted into the recessed portion in the thread engagement state.

6. The fastener according to claim 3, wherein:
the protruding portion has a convexly curved surface shape on the front side in the relative rotation direction and a stepped shape on the rear side in the relative rotation direction; and
the recessed portion has a concavely curved surface shape on the rear side in the relative rotation direction, the concavely curved surface shape corresponding to that on the front side of the protruding portion in the relative rotation direction, and a stepped shape on the front side in the relative rotation direction, the stepped shape corresponding to that on the rear side of the protruding portion in the relative rotation direction.

7. The fastener according to claim 1, wherein the screw portion has a tubular shape with a through-hole formed on an inner side thereof, the through-hole communicating with the screw hole in the thread engagement state between the male screw surface and the female screw surface.

8. The fastener according to claim 7, further comprising:
a male screw-side pipe that is provided on a radially outer side of an axial center in the through-hole so that one end portion thereof faces in the relative rotation direction; and
a female screw-side pipe that is provided on a radially outer side of an axial center in the screw hole so that one end portion thereof faces in the relative rotation direction, the one end portion fitting into the one end portion of the male screw-side pipe in the thread engagement state.

9. A male-screw-side member comprising:
a male screw surface that is arranged in part of a screw portion in an outer peripheral direction and where male screw-side screw threads are formed; and
an outer peripheral piece that is alternately arranged with the male screw surface in the outer peripheral direction to form an outer periphery of the screw portion, the outer peripheral piece not having the male screw-side screw threads formed thereon,
the male screw-side screw threads being configured so that a width in a radial direction of the screw portion increases from a front side in a relative rotation direction toward a rear side in the relative rotation direction during a thread engagement with a screw hole.

10. A female-screw-side member comprising:
a female screw surface that is arranged in part of a screw hole in an inner peripheral direction and where female screw-side screw threads are formed; and
an inner peripheral piece that is alternately arranged with the female screw surface in the inner peripheral direction to form an inner periphery of the screw hole, the inner peripheral piece not having the female screw-side screw threads formed thereon,
the female screw-side screw threads being configured so that a width in a radial direction of the screw hole decreases from a front side in a relative rotation direction toward a rear side in the relative rotation direction during a thread engagement with a screw portion.

11. The fastener according to claim 4, wherein:
the protruding portion has a convexly curved surface shape on the front side in the relative rotation direction and a stepped shape on the rear side in the relative rotation direction; and
the recessed portion has a concavely curved surface shape on the rear side in the relative rotation direction, the concavely curved surface shape corresponding to that on the front side of the protruding portion in the relative rotation direction, and a stepped shape on the front side in the relative rotation direction, the stepped shape corresponding to that on the rear side of the protruding portion in the relative rotation direction.

12. The fastener according to claim 5, wherein:
the protruding portion has a convexly curved surface shape on the front side in the relative rotation direction and a stepped shape on the rear side in the relative rotation direction; and
the recessed portion has a concavely curved surface shape on the rear side in the relative rotation direction, the concavely curved surface shape corresponding to that on the front side of the protruding portion in the relative rotation direction, and a stepped shape on the front side in the relative rotation direction, the stepped shape corresponding to that on the rear side of the protruding portion in the relative rotation direction.
